(19) United States
(12) Patent Application Publication
(10) Pub. No.: US 2012/0115489 A1
(43) Pub. Date: May 10, 2012

(54) METHOD AND APPARATUS FOR HANDOVER

(75) Inventors: Yanglai Shuai, Shanghai (CN); Xiaobo Wu, Shanghai (CN)

(73) Assignee: Huawei Technologies Co., Ltd., Shenzhen (CN)

(21) Appl. No.: 13/350,406

(22) Filed: Jan. 13, 2012

Related U.S. Application Data
(63) Continuation of application No. PCT/CN2010/075177, filed on Jul. 15, 2010.

(30) Foreign Application Priority Data
Jul. 15, 2009 (CN) 200910108783.4

(51) Int. Cl. H04W 36/14

(52) U.S. Cl. 455/438

(57) ABSTRACT

The present invention discloses a method and an apparatus for handover applied to the communication field. The method includes: receiving indication information from an MME, where the indication information is used to indicate whether a network side and a terminal support enhanced CSFB to a 1x network; if the network side and the terminal support enhanced CSFB, determining to perform enhanced CSFB to the 1x network and determining to perform handover to an HRPD network; and sending a first message to the terminal to trigger the terminal to perform enhanced CSFB to the 1x network and perform handover to the HRPD network. By using the method, when 1xRTT CSFB occurs or when SRVCC is performed, the UE can continue to use PS data services with a shorter handover time, and therefore, a customer has a good customer experience.

### CROSS-REFERENCE TO RELATED APPLICATIONS

This application is a continuation of International Application No. PCT/CN2010/075177, filed on Jul. 15, 2010, which claims priority to Chinese Patent Application No. 200910108783.4, filed on Jul. 15, 2009, both of which are hereby incorporated by reference in their entireties.

### FIELD OF THE INVENTION

The present invention relates to the communications field, and in particular, to a method and an apparatus for handover.

### BACKGROUND OF THE INVENTION

Currently, a Long Term Evolution (Long Term Evolution, LTE for short) network/a System Architecture Evolution (System Architecture Evolution, SAE) network becomes an important research topic. The LTE aims to provide a network capable of reducing a delay, increasing user data rate, improving system capacity, and performing converge with low-cost. The LTE provides packet switched (packet switched, PS) services over the Internet Protocol (Internet Protocol, IP for short).

It can be known from the prior art that, in an LTE system, voice service data is generally controlled by an IMS (IP Multimedia Subsystem, IP multimedia subsystem). Therefore, in the SAE/LTE, voice services are generally referred to as VoIP (Voice Over IP, voice is transmitted over IP) services. However, conventional voice services are generally born over CS TDM (Circuit Switched, circuit switched domain; Time Division Multiplexing, time division multiplexing). Deployment of the LTE in the initial phase is hot-spot coverage, and networks such as the GSM (Global System for Mobile Communication, second-generation global system for mobile communication)/UMTS (Universal Mobile Telecommunication System, third-generation global system for mobile communication), and CDMA2000 1x (1x network for short) that provide circuit switched domain voice services may be regarded as full coverage to some extent. In the early deployment phase of the LTE, possibly the IMS (IP Multimedia Subsystem, IP multimedia subsystem) is not deployed, and high-speed data services are mainly provided.

Currently, many 1x network operators hope to have a transition from the network to the LTE system gradually, and hope to be capable of reusing 1x networks so that the LTE network can transfer CS services to terminals when performing services. A terminal with such CS fallback (CSFB, CS fallback) capability may pre-register on the 1x CS domain when connecting to an E-UTRAN (Evolved Universal Terrestrial Radio Access Network, evolved universal terrestrial radio access network), so as to establish a voice call in the CS domain by a means of 1x access.

When 1xRTT CSFB occurs or when SRVCC (Single Radio Voice Call Continuity, single radio voice call continuity) is performed, for a bearer of a UE (User Equipment, user equipment), the SAE/LTE network releases a GBR (Guaranteed Bit Rate, guaranteed bit rate) bearer, and suspends a Non-GBR (non guaranteed bit rate) bearer. As a result, the UE cannot continue to use PS data services, or the UE can continue to use PS services but the handover takes a relatively long time, which deteriorates the user experience.

### SUMMARY OF THE INVENTION

Embodiments of the present invention provide a method, an apparatus, and a system for handover, so that when 1xRTT CSFB occurs or when SRVCC is performed, a UE can continue to use PS data services with a shorter handover time.

An embodiment of the present invention provides a method for handover, including: receiving indication information from an MME (Mobility Management Entity, mobility management entity), where the indication information is used to indicate whether a network side and a terminal support enhanced CSFB (Circuit Switched Fallback, circuit switched fallback) to a 1x network; and if the network side and the terminal support enhanced CSFB to the 1x network, determining to perform enhanced CSFB to the 1x network and determining to perform handover to an HRPD network; sending a first message to the terminal, where the first message is used to trigger the terminal to perform enhanced CSFB to the 1x network and perform handover to the HRPD network; and if the network side and/or terminal does not support enhanced CSFB to the 1x network, initiating ordinary CSFB or ending a procedure.

An embodiment of the present invention provides another method for handover, including: obtaining SVDO (simultaneous voice and data only) capability information and SRVCC capability information of a terminal; determining, according to network conditions, to perform an SRVCC procedure to a 1x network and handover to an HRPD network; and sending a second message to the terminal, where the second message is used to trigger the terminal to perform handover to the 1x network and perform handover to the HRPD network.

An embodiment of the present invention provides an apparatus for handover, where the apparatus includes a receiving module, a determining module, and a sending module, where:
the receiving module is configured to receive indication information from an MME, where the indication information is used to indicate whether a network side and a terminal support enhanced CSFB to a 1x network;
the determining module is configured to determine to perform enhanced CSFB to the 1x network and determine to perform handover to an HRPD network when the network side and the terminal support enhanced CSFB to the 1x network;
the sending module is configured to send a first message to the terminal when the determining module determines to perform enhanced CSFB to the 1x network and determines to perform handover to the HRPD network, where the first message is used to trigger the terminal to perform enhanced CSFB to the 1x network and perform handover to the HRPD network; and
the determining module is further configured to initiate ordinary CSFB or end a procedure when the network side and/or terminal does not support enhanced CSFB to the 1x network.

An embodiment of the present invention provides another apparatus for handover, where the apparatus includes an obtaining module, a determining module, and a sending module, where:
the obtaining module is configured to obtain SVDO capability information and SRVCC capability information of a terminal;
the determining module is configured to determine, according to network conditions, to perform an SRVCC procedure to a 1x network and handover to an HRPD network; and
the sending module is configured to send a second message to the terminal, where the second message is used to trigger the terminal to perform handover to the 1x network and perform handover to the HRPD network.

According to embodiments of the present invention, when 1xRTT CSFB occurs or when SRVCC is performed, the UE can continue to use PS data services with a shorter handover time, so that a customer has a good customer experience.

### BRIEF DESCRIPTION OF THE DRAWINGS

FIG. 1 is a flow chart of a method for handover according to an embodiment of the present invention;

FIG. 2 is a signaling diagram of a method for handover according to a second embodiment of the present invention;

FIG. 3 is a signaling diagram of another method for handover according to a third embodiment of the present invention;

FIG. 4 is a signaling diagram of another method for handover according to a fourth embodiment of the present invention;

FIG. 5 is a signaling diagram of another method for handover according to a fifth embodiment of the present invention;

FIG. 6 is a schematic structure diagram of an apparatus for handover according to a sixth embodiment of the present invention; and

FIG. 7 is a schematic structure diagram of another apparatus for handover according to a seventh embodiment of the present invention.

### DETAILED DESCRIPTION OF THE EMBODIMENTS

Specific implementations of embodiments of the present invention are described in detail below with reference to the accompanying drawings of the specification.

Embodiments of the present invention are mainly based on the CSFB (CS Fallback, CS domain voice fallback) mobile originated procedure. It should be noted that, those skilled in the art should understand that the processing of the CSFB mobile terminated procedure is similar, which is not described here.

Those skilled in the art should understand that, according to the technical solutions provided by embodiments of the present invention, approximate or similar technical solutions may be applied in the CSFB procedure from LTE to 2G/3G, or applied in the SRVCC (Single Radio Voice Call Continuity, single radio voice call continuity) procedure. The technical solutions above shall fall within the protection scope of the present invention.

In the following embodiments, in the process of preparing for handover to the 1xRTT network, if the target 1xRTT base station cannot allocate sufficient resources, the 1xRTT handover preparation fails; in the process of preparing for handover to the HRPD network (High Rate Packet Data Network, high rate packet data network), if the target HRPD base station cannot allocate sufficient resources, the HRPD handover preparation fails; for the foregoing exceptional cases, the EUTRAN may perform coordination, and may carry the following information to the terminal by extending a DL information Transfer message or a Mobility From EUTRAN (command for handover from the EUTRAN) message:

1. If the 1xRTT handover preparation fails, but the HRPD handover preparation succeeds, the message is extended to carry 1xRTT failure information and HRPD handover information, for example, cell configuration information.

2. If the 1xRTT handover preparation succeeds, but the HRPD handover preparation fails, the message is extended to carry 1xRTT handover information, for example, cell configuration information and HRPD failure information.

3. If both the 1xRTT handover preparation and the HRPD handover preparation fail, the message is extended to carry 1xRTT failure information and HRPD failure information.

If the EUTRAN does not perform coordination of the handover preparation message, the handover failure information is sent to the terminal through a DL information Transfer message. Three scenarios also exist in this mode:

1. If the 1xRTT handover preparation fails, but the HRPD handover preparation succeeds, the 1xRTT handover preparation failure information is sent to the terminal through a DL information Transfer message, while the HRPD handover preparation success message is sent to the terminal through a Mobility From EUTRAN message.

2. If the 1xRTT handover preparation succeeds, but the HRPD handover preparation fails, the 1xRTT handover preparation success message is sent to the terminal through a Mobility From EUTRAN message, while the HRPD handover preparation failure information is sent to the terminal through a DL information Transfer message.

3. If both the 1xRTT handover preparation and the HRPD handover preparation fail, the 1xRTT handover preparation failure information and the HRPD handover preparation failure information are sent to the terminal respectively through different DL information Transfer messages.

In the following embodiments, if the EUTRAN is notified that the terminal supports enhanced CSFB capabilities, and the EUTRAN itself is configured to support enhanced CSFB, but in fact, an MME (Mobility Management Entity, mobility management entity) does not support enhanced CSFB, the MME needs to carry indication information in the message returned to the EUTRAN, for example, CDMA2000 HO Status, notifying the EUTRAN that enhanced CSFB is not supported. After receiving the information, the EUTRAN may control whether to initiate ordinary CSFB or directly reject the CSFB procedure.

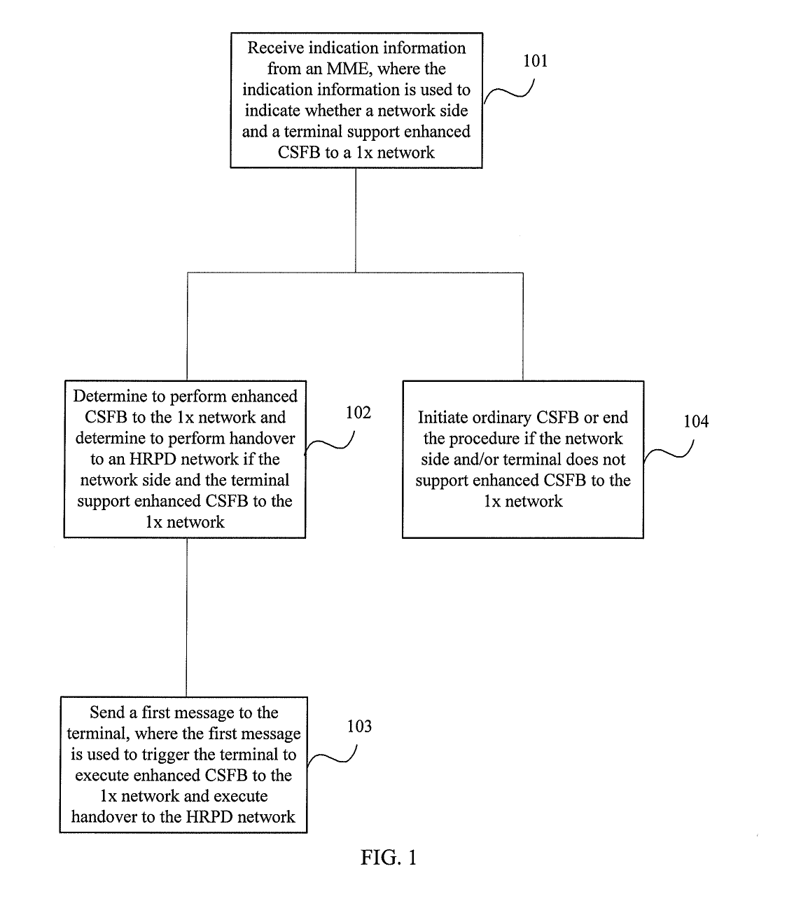

The specific procedure of the first embodiment of the present invention is described below with reference to FIG 1.

Step 101: Receive indication information from an MME, where the indication information is used to indicate whether a network side and a terminal support enhanced CSFB to a 1x network.

Step 102: Determine to perform enhanced CSFB to the 1x network and determine to perform handover to an HRPD network if the network side and the terminal support enhanced CSFB to the 1x network.

Step 103: Send a first message to the terminal, where the first message is used to trigger the terminal to perform enhanced CSFB to the 1x network and perform handover to the HRPD network.

Step 104: Initiate ordinary CSFB or end the procedure if the network side and/or terminal does not support enhanced CSFB to the 1x network.

According to the embodiment, when 1xRTT CSFB occurs, the UE can continue to use PS data services with a shorter handover time, so that a customer has a good customer experience.

In addition, another embodiment is further provided.

Step 101a: Obtain SVDO capability information and SRVCC capability information of a terminal.

Step 102a: According to network conditions, determine to perform an SRVCC procedure to a 1x network and handover to an HRPD network.

Step 103a: Send a second message to the terminal, where the second message is used to trigger the terminal to perform handover to the 1x network and perform handover to the HRPD network.

According to the embodiment, when SRVCC is performed, the UE can continue to use PS data services with a shorter handover time, so that a customer has a good customer experience.

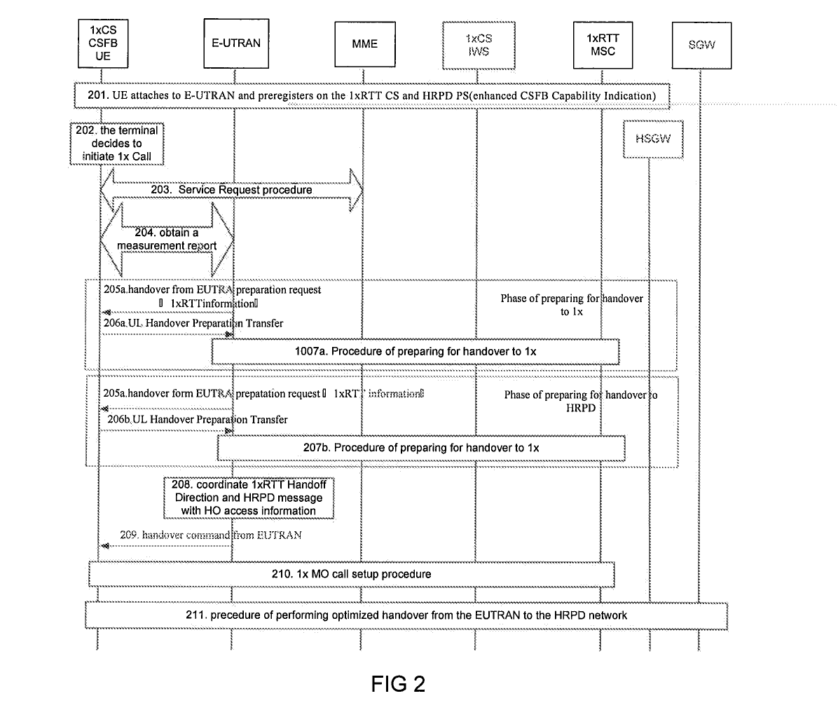

The second embodiment of the present invention is described below with reference to FIG. 2. The embodiment describes a network-controlled coordinated control method for enhanced CSFB and PS optimized handover.

Step 201: The UE attaches to the E-UTRAN and pre-registers on the 1xRTT CS through an S102 tunnel, and also pre-registers on the HRPD network. During the process of attaching to the E-UTRAN, the UE reports its capability of supporting SVDO (simultaneous voice and data only, here means simultaneous 1x and the HRPD operation, indicating that the UE can receive and send 1xRTT data and eHRPD data simultaneously) to the network side. The SVDO capability of the UE may be reported as a network capability of the UE, or may be reported as a radio capability of the UE.

In addition, the terminal reports an enhanced CSFB capability support indication (enhanced CSFB capability support indication) to the network side, indicating that the terminal supports enhanced CSFB; after receiving the indication, if the MME determines that the MME also supports enhanced CSFB, the MME sends enhanced CSFB Operation Possible (enhanced voice fallback operation possible) indication information to the EUTRAN through an S1 message, for example, an initial Context setup request (initial Context setup request) message; according to the indication, the EUTRAN can judge that both the network side and the terminal support enhanced CSFB; the enhanced CSFB capability support indication of the terminal may be reported as a network capability of the terminal, or may be reported as a radio capability of the terminal.

Step 202: The UE decides to initiate a 1x mobile originated procedure, where the 1x mobile originated procedure is an ordinary CSFB mobile originated procedure.

Step 203: The terminal triggers a Service Request (service request) procedure, and carries a CSFB indicator to the MME in the procedure, so that the MME sends the information including the CSFB indicator to the EUTRAN.

In an embodiment, if the terminal does not report an enhanced CSFB capability support indication to the network in step 201, the Service Request (service request) message sent by the terminal carries the enhanced CSFB indicator information to the MME; if the MME determines, according to the received enhanced CSFB indicator information, that the MME itself also supports enhanced CSFB (enhanced voice fallback), the MME forwards or sends the enhanced CSFB indicator information to the EUTRAN, where the indicator information is used to indicate that the network side and the terminal support enhanced CSFB to the 1x network. This step may be implemented by extending the existing CSFB indicator information element, so that the information element can support the ordinary CSFB indicator and the enhanced CSFB indicator.

Step 204: Optionally, the EUTRAN obtains a measurement report including HRPD and 1xRTT measurement information from the terminal.

Steps 205a-207a: The EUTRAN triggers the terminal to perform the process of preparing for handover to the 1xRTT. The EUTRAN sends to the terminal a handover from E UTRA preparation request message, where the handover preparation request message includes information about the target network, and the terminal sends a UL Handover Preparation Transfer message to the EUTRAN.

In the process, if the terminal reports the enhanced CSFB capability support indication as a radio capability, the S1-AP message sent by the EUTRAN to the MME needs to indicate that the MME needs to perform enhanced CSFB; the function may also be judged by the MME according to parameters in the existing S1-AP message, and the MME determines that enhanced CSFB needs to be performed, for example, if the S1-AP message includes an SRVCC information parameter or a RAND parameter or a CDMA2000 HO indicator parameter, the MME determines to perform CSFB currently, and therefore the MME determines that it is necessary to perform enhanced CSFB. When the enhanced CSFB capability support indication reported by the terminal to the MME is reported as a radio capability of the terminal, if configurations of the MME and the EUTRAN are inconsistent, and the enhanced CSFB cannot be performed, the MME notifies the EUTRAN of performing ordinary CSFB.

Steps 205b-207b: The EUTRAN triggers the terminal to perform the process of preparing for handover to the HRPD. The EUTRAN sends to the terminal a handover from E UTRA preparation request message, where the handover request includes information about the target network, and the terminal sends a UL Handover Preparation Transfer message to the EUTRAN.

Step 208: According to the SVDO capability supported by the UE and the received enhanced CSFB Operation Possible information, the EUTRAN determines that it is necessary to perform enhanced CSFB. Optionally, the EUTRAN may perform PS optimized handover according to a preconfigured policy; if the network cannot perform PS optimized handover or optimized handover fails, PS non-optimized handover is performed. For the specific steps of non-optimized handover to the PS domain, reference may be made to the corresponding steps in the third embodiment. Optionally, PS optimized handover may also be determined according to PS optimized handover information and/or measurement report information. The EUTRAN coordinates the Handoff Direction message in the process of preparing for handover to the 1xRTT network and the HRPD message with handover access information (HRPD message with HO access information) in the process of preparing for handover to the HRPD network, where the two messages are embedded in the S1-AP message sent by the MME to the eNB. The Handoff Direction message carries access configuration information for handover to the 1xRTT network.

Step 209: The EUTRAN constructs a Mobility From EUTRAN message and sends the message to the terminal, where the message carries both the 1xRTT Handoff Direction message and HRPD message with HO access information simultaneously. The terminal uses the received 1xRTT handoff Direction as the handover command for 1xRTT handover, and initiates access to the 1xRTT; uses the received HRPD message with HO access information as the handover command for HRPD handover, and initiates access to the HRPD.

Step 210: The terminal initiates a 1x MO call setup procedure.

Step 211: The terminal initiates an optimized handover procedure to the HRPD.

Those skilled in the art should understand that there is no time sequence between step 210 and step 211, that is, step 210 may be performed first, or step 211 may be performed first, or step 210 and step 211 may be performed simultaneously.

In the process, the EUTRAN may also not perform coordination and synchronization of the 1xRTT handoff Direction and HRPD message with HO access info. Instead, after receiving either message, the EUTRAN sends the message to the terminal through the corresponding Mobility From EUTRAN message, that is, the Mobility From EUTRAN message including the handoff Direction message and the Mobility From EUTRAN message including the HRPD message with HO access info. If the EUTRAN determines that it is necessary to perform enhanced CSFB and PS optimized handover, it is ensured that radio resources are released only after the 1xRTT handoff Direction and the HRPD message with HO access info are sent; while the terminal performs air interface handover only after receiving the 1xRTT handoff Direction and HRPD message with HO access info, that is, the handover from the air interface of the LTE to the air interface of the 1x network and the air interface of the HRPD.

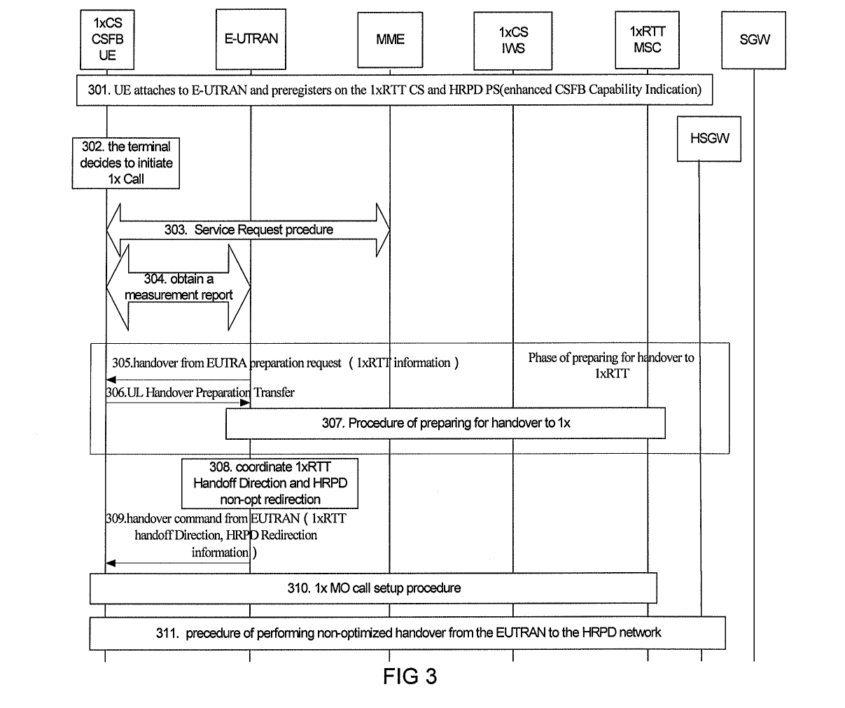

The third embodiment of the present invention is described below with reference to FIG. 3B. The embodiment describes a coordinated control method for network-controlled enhanced CSFB and PS non-optimized handover.

Step 301: The UE attaches to the E-UTRAN and pre-registers on the 1xRTT CS through an S102 tunnel, and also pre-registers on the HRPD network. During the process of attaching to the E-UTRAN, the UE reports its capability of supporting SVDO to the network side. The SVDO capability of the UE may be reported as a network capability of the UE, or may be reported as a radio capability of the UE.

In addition, the terminal reports an enhanced CSFB capability support indication (enhanced CSFB capability support indication) to the network side; after receiving the indication, if the MME determines that the MME also supports enhanced CSFB, the MME sends enhanced CSFB Operation Possible indication information to the E-UTRAN through an S1 message, for example, an initial Context setup request message; according to the indication, the E-UTRAN can judge that both the network side and the terminal support enhanced CSFB; the enhanced CSFB capability support indication of the terminal may be reported as a network capability of the terminal, or may be reported as a radio capability of the terminal.

Step 302: The UE decides to initiate a 1x mobile originated procedure, where the 1x mobile originated procedure is an ordinary CSFB mobile originated procedure.

Step 303: The terminal triggers a Service Request procedure, and carries a CSFB indicator to the MME in the procedure, so that the MME sends the information including the CSFB indicator to the EUTRAN.

In an embodiment, if the terminal does not carry an enhanced CSFB capability support indication to the network in step 301, the Service Request message sent by the terminal carries the enhanced CSFB indicator information to the MME; if the MME determines, according to the received enhanced CSFB indicator information, that the MME itself also supports enhanced CSFB, the MME forwards or sends the enhanced CSFB indicator information to the EUTRAN, where the indicator information is used to indicate that the network side and the terminal support enhanced CSFB to the 1x network. This step may be implemented by extending the existing CSFB indicator information element, so that the information element can support the ordinary CSFB indicator and the enhanced CSFB indicator.

Step 304: Optionally, the EUTRAN obtains a measurement report including HRPD and 1xRTT measurement information from the terminal, where the measurement report is the same as the measurement report in the prior art.

Steps 305a-307a: The EUTRAN triggers the terminal to perform the process of preparing for handover to the 1xRTT. The EUTRAN sends to the terminal a handover from E UTRA preparation request message, where the handover request includes information about the target network, and the terminal sends a UL Handover Preparation Transfer message to the EUTRAN.

In the process, if the enhanced CSFB capability support indication is reported as a radio capability, the S1-AP message sent by the EUTRAN to the MME needs to indicate that the MME needs to perform enhanced CSFB; the function may also be judged by the MME according to parameters in the existing S1-AP message, and the MME determines that enhanced CSFB needs to be performed, for example, if the S1-AP message includes an SRVCC information parameter or a RAND parameter, but the MME has no SRVCC indication, the MME determines that it is necessary to perform enhanced CSFB. When the enhanced CSFB capability support indication reported by the terminal to the MME is reported as a radio capability of the terminal, if configurations of the MME and the EUTRAN are inconsistent, and the enhanced CSFB cannot be performed, the MME notifies the EUTRAN of performing ordinary CSFB.

Step 308: According to the SVDO capability of the UE and the received enhanced CSFB Operation Possible information, the EUTRAN determines that it is necessary to perform enhanced CSFB. Optionally, PS non-optimized handover may be determined according to at least one of the PS non-optimized handover support information, measurement report information, and preconfigured policy. The EUTRAN coordinates the Handoff Direction message in the process of preparing for handover to the 1xRTT network and the HRPD message with HO access information in the process of preparing for handover to the HRPD network. The Handoff Direction message in the process of preparing for handover to the 1xRTT network is embedded in the S1-AP message sent by the MME to the eNB. The Handoff Direction message carries the access configuration information for 1xRTT handover; in addition, the EUTRAN constructs an HRPD non-optimized Redirection message, where the message may include at least one of the HRPD Carrier information, HRPD cell information, and HRPD paging channel information. The EUTRAN coordinates the HRPD non-optimized Redirection message and the Handoff Direction message.

Step 309: The EUTRAN constructs a Mobility From EUTRAN message and sends the message to the terminal, where the message carries both the 1xRTT Handoff Direction message and HRPD non-optimized Redirection message simultaneously. The terminal uses the received 1xRTT handoff Direction message as a handover command for 1xRTT handover, and initiates access to the 1xRTT; the terminal obtains information required for non-optimized handover to the HRPD from the HRPD non-optimized Redirection message, and triggers non-optimized handover to the HRPD.

Step 310: The terminal initiates a 1xRTT call setup procedure.

Step 311: The terminal initiates a non-optimized handover procedure from the EUTRAN to the HRPD network.

It should be noted that there is no time sequence between step 310 and 311, that is, step 310 may be performed first, or the step 311 may be performed first, or step 310 and step 311 may be performed simultaneously.

In the process, the EUTRAN may also not coordinate the 1xRTT handoff Direction and HRPD non-optimized Redirection messages, but send an RRC Connection Release message and a Mobility From EUTRAN message to the terminal respectively. If the EUTRAN determines that it is necessary to perform enhanced CSFB and PS non-optimized handover, the EUTRAN releases corresponding radio resources only after sending the 1xRTT handoff Direction message and the HRPD Redirection message; and the terminal performs air interface handover only after receiving the 1xRTT handoff Direction message and HRPD Redirection message, that is, the handover from the air interface of the LTE to the air interface of the 1x network and the air interface of the HRPD.

By using the method in the preceding embodiment, the network side may coordinate capabilities of supporting enhanced CSFB capability by the terminal and the network, and coordinate handover commands for enhanced CSFB and PS handover. Compared with ordinary CSFB, enhanced CSFB has better performance, especially the handover speed.

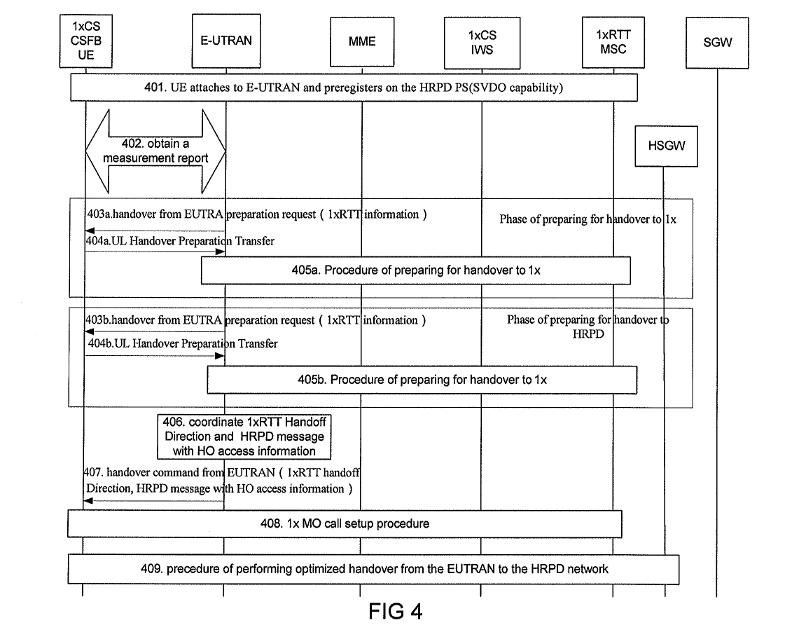

The fourth embodiment of the present invention is described below with reference to FIG. 4. The embodiment describes a coordinated control method for network-controlled SRVCC and PS optimized handover. As shown in FIG. 4:

In step 401, the terminal sends the SVDO capability information of the terminal and the SRVCC capability information of the terminal to the network side. The SVDO capability of the terminal may be a radio capability of the terminal, or may be a network capability of the terminal; the capability of supporting SRVCC by the terminal is the network capability of the terminal.

In step 402, the EUTRAN obtains a measurement report including HRPD and 1xRTT measurement information from the terminal.

In steps 403a-405a, the EUTRAN triggers the terminal to perform the process of preparing for handover to the 1xRTT. The EUTRAN sends to the terminal a handover from E UTRA preparation request message, where the handover preparation request message includes information about the target network, and the terminal sends a UL Handover Preparation Transfer message to the EUTRAN.

In steps 403b-405b, the EUTRAN triggers the terminal to perform the process of preparing for handover to the HRPD. The EUTRAN sends to the terminal a handover from E UTRA preparation request message, where the handover request includes information about the target network, and the terminal sends a UL Handover Preparation Transfer message to the EUTRAN.

In step 406, the EUTRAN determines that it is necessary to perform SRVCC to the 1x network according to the SVDO capability of the UE, SRVCC support information, and measurement report information; and determines to perform optimized handover to the HRPD network according to the measurement report information and according to at least one of preconfigured policy, PS optimized handover information, and measurement report information. Other coordination steps of the EUTRAN are the same as the corresponding coordination steps in the second embodiment.

Steps 407-409 are the same as the corresponding steps in the second embodiment.

In the process, the EUTRAN may also not coordinate the 1xRTT handoff Direction and HRPD message with HO access info. Instead, after receiving either message, the EUTRAN sends the message to the terminal through the corresponding Mobility From EUTRAN message, and if the EUTRAN determines that it is necessary to perform SRVCC and PS optimized handover, the EUTRAN ensures that radio resources are released only after the 1xRTT handoff Direction message and the HRPD message with HO access info are sent; the terminal performs air interface handover only after receiving the 1xRTT handoff Direction message and HRPD message with HO access info, that is, the handover from the air interface of the LTE to the air interface of the 1x network and the air interface of the HRPD network.

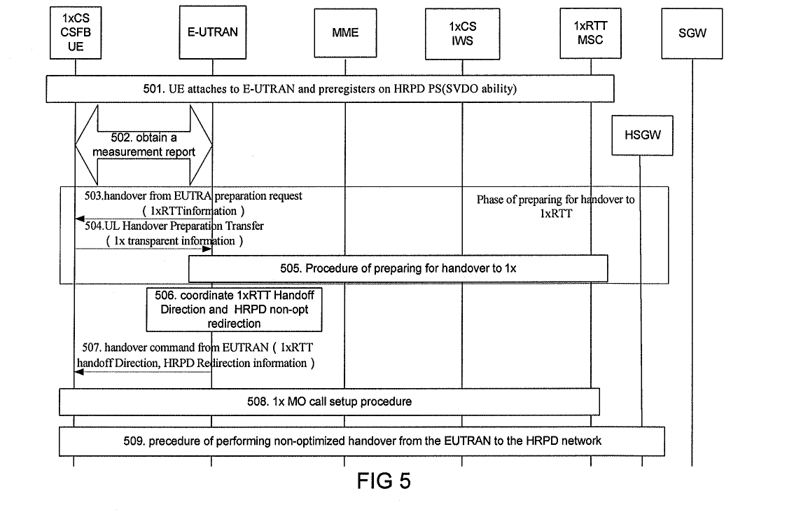

The fifth embodiment of the present invention is described below with reference to FIG. 5. The embodiment describes a coordinated control method for network-controlled SRVCC and PS non-optimized handover.

In step 501, the terminal sends the SVDO capability information of the terminal and the SRVCC capability information of the terminal to the network side. The SVDO capability of the terminal may be a radio capability of the terminal, or may be a network capability of the terminal; the capability of supporting SRVCC by the terminal is the network capability of the terminal.

In step 502, the EUTRAN obtains a measurement report including HRPD and 1xRTT measurement information from the terminal.

In steps 503-505, the EUTRAN triggers the terminal to perform the process of preparing for handover to the 1xRTT. The EUTRAN sends to the terminal a handover from E UTRA preparation request message, where the handover request includes information about the target network, and the terminal sends a UL Handover Preparation Transfer message to the EUTRAN.

In step 506, the EUTRAN determines that it is necessary to perform SRVCC according to the SVDO capability information of the UE, SRVCC support information, and measurement report information; and determines to perform non-optimized handover to the HRPD network according to at least one of the measurement report information, preconfigured policy, optimized handover failure, and the network's nonsupport of optimized handover. Other coordination steps of the EUTRAN are the same as the corresponding coordination steps in the third embodiment.

Steps 507-509 are the same as the corresponding steps in the third embodiment.

In the process, the EUTRAN may also not coordinate the 1xRTT handoff Direction and HRPD Redirection messages, but send an RRC Connection Release message and a Mobility From EUTRAN message to the terminal respectively. If the EUTRAN determines that it is necessary to perform SRVCC and PS non-optimized handover, the EUTRAN releases radio resources only after sending the 1xRTT handoff Direction message and the HRPD Redirection message; the terminal performs air interface handover only after receiving the 1xRTT handoff Direction message and HRPD Redirection message, that is, the handover from the air interface of the LTE to the air interface of the 1x network and the air interface of the HRPD.

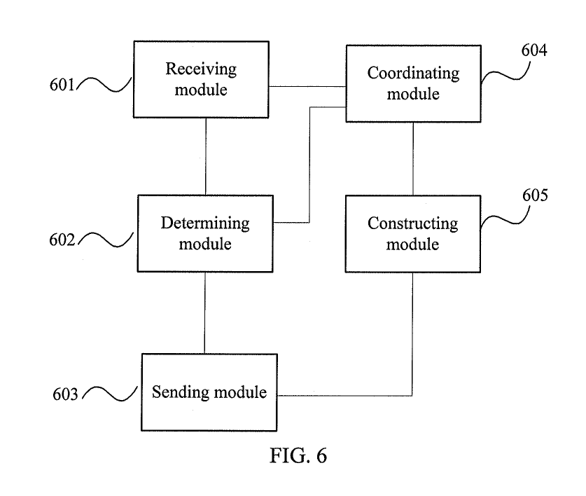

An apparatus handover provided by an embodiment of the present invention is described below with reference to FIG. 6.

An embodiment of the present invention provides an apparatus for handover. The apparatus includes a receiving module 601, a determining module 602, and a sending module 603. The receiving module 601 receives indication information from an MME, where the indication information is used to indicate whether a network side and a terminal support enhanced CSFB to a 1x network. The determining module 602 is configured to determine to perform enhanced CSFB to the 1x network and determine to perform handover to an HRPD network when the network side and the terminal support enhanced CSFB to the 1x network. The sending module 603 is configured to send a first message to the terminal when the determining module 602 determines to perform enhanced CSFB to the 1x network and determines to perform handover to the HRPD network, where the first message is used to trigger the terminal to perform enhanced CSFB to the 1x network and perform handover to the HRPD network. The determining module 602 is further configured to initiate ordinary CSFB or end a procedure when the network side and/or terminal does not support enhanced CSFB to the 1x network.

In addition, the receiving module 601 is further configured to receive a measurement report including HRPD and 1xRTT measurement information from the terminal, and send the measurement report information to the determining module 602.

The determining module 602 includes a first determining unit and a second determining unit. The first determining unit is configured to determine, according to network conditions, to perform optimized handover to the HRPD network; and the second determining unit is configured to determine, according to network conditions, to perform non-optimized handover to the HRPD network.

The apparatus further includes a coordinating module 604 and a constructing module 605. The receiving module 601 is further configured to receive a Handoff Direction message in the process of preparing for handover to the 1x network; the coordinating module 604 is configured to coordinate, when the first determining unit determines to perform optimized handover to the HRPD network, the Handoff Direction message received by the receiving module 601 in the process of preparing for handover to the 1x network and the HRPD message with HO access information received in the process of preparing for handover to the HRPD network; the constructing module 605 is configured to construct a Mobility From EUTRAN message, where the Mobility From EUTRAN message includes the Handoff Direction message and the HRPD message with HO access information; and the sending module 603 is further configured to send the Mobility From EUTRAN message to the terminal;
or
the constructing module 605 is configured to construct an HRPD non-optimized Redirection message, where the HRPD non-optimized Redirection message includes at least one of the HRPD Carrier information, HRPD cell information, and HRPD paging channel information; the coordinating module 604 is further configured to coordinate, when the second determining unit determines to perform non-optimized handover to the HRPD network, the Handoff Direction message obtained by the receiving module 601 in the process of preparing for handover to the 1x network and the HRPD non-optimized Redirection message constructed by the constructing module 605; the constructing module 605 is configured to construct a Mobility From EUTRAN message, where the Mobility From EUTRAN message includes the Handoff Direction message and the HRPD non-optimized Redirection message; and the sending module 603 is further configured to send the Mobility From EUTRAN message to the terminal.

The sending module 603 is further configured to send a Mobility From EUTRAN message including the handoff Direction message and a Mobility From EUTRAN message including the HRPD message with HO access info to the terminal when the first determining unit determines to perform optimized handover to the HRPD network, where the Mobility From EUTRAN message including the handoff Direction message is used to trigger the terminal to perform handover to the 1x network, and the Mobility From EUTRAN message including the HRPD message with HO access info is used to trigger the terminal to perform handover to the HRPD network; or
the sending module 603 is further configured to send an RRC Connection Release message and a Mobility From EUTRAN message to the terminal when the second determining unit determines to perform non-optimized handover to the HRPD network, where the RRC Connection Release message is used to trigger the terminal to perform handover to the 1x network, and the Mobility From EUTRAN message is used to trigger the terminal to perform non-optimized handover to the HRPD network.

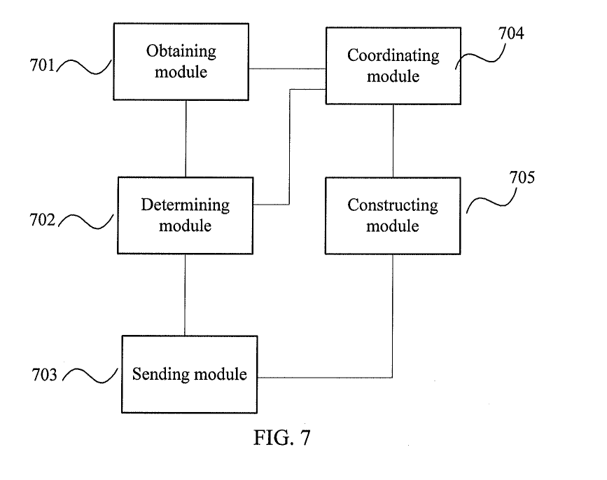

Another apparatus for handover provided by an embodiment of the present invention is described below with reference to FIG. 7.

Another apparatus for handover provided by an embodiment of the present invention includes an obtaining module 701, a determining module 702, and a sending module 703. The obtaining module 701 is configured to obtain SVDO capability information and SRVCC capability information of a terminal. The determining module 702 is configured to determine, according to network conditions, to perform an SRVCC procedure to a 1x network and handover to an HRPD network. The sending module 703 is configured to send a second message to the terminal, where the second message is used to trigger the terminal to perform handover to the 1x network and perform handover to the HRPD network.

The obtaining module 701 is further configured to receive a measurement report including HRPD and 1xRTT measurement information from the terminal, and send the measurement report information to the determining module 702.

The determining module 702 includes a third determining unit and a fourth determining unit. The third determining unit is configured to determine, according to network conditions, to perform optimized handover to the HRPD network. The fourth determining unit is configured to determine, according to network conditions, to perform non-optimized handover to the HRPD network.

The apparatus further includes a coordinating module 704 and a constructing module 705. The obtaining module 701 is further configured to receive a Handoff Direction message in the process of preparing for handover to the 1x network; the coordinating module 704 is configured to coordinate the Handoff Direction message received by the obtaining module 701 in the process of preparing for handover to the 1x network and the HRPD message with HO access information received in the process of preparing for handover to the HRPD network; the constructing module 705 is configured to construct a Mobility From EUTRAN message, where the Mobility From EUTRAN message includes the Handoff Direction message and the HRPD message with HO access information; and the sending module 705 is further configured to send the Mobility From EUTRAN message to the terminal;
or
the constructing module 705 is configured to construct an HRPD non-optimized Redirection message, where the HRPD non-optimized Redirection message includes at least one of the HRPD Carrier information, HRPD cell information, and HRPD paging channel information; the coordinating module 704 is further configured to coordinate, when the fourth determining unit determines to perform non-optimized handover to the HRPD network, the Handoff Direction message obtained by the obtaining module 701 in the process of preparing for handover to the 1x network and the HRPD non-optimized Redirection message constructed by the constructing module 705; the constructing module 705 is configured to construct a Mobility From EUTRAN message, where the Mobility From EUTRAN message includes the Handoff Direction message and the HRPD non-optimized Redirection message; and the sending module 703 is further configured to send the Mobility From EUTRAN message to the terminal.

The sending module 703 is further configured to send a Mobility From EUTRAN message including the handoff Direction message and a Mobility From EUTRAN message including the HRPD message with HO access info to the terminal when the third determining unit determines to perform optimized handover to the HRPD network, where the Mobility From EUTRAN message including the handoff Direction message is used to trigger the terminal to perform handover to the 1x network, and the Mobility From EUTRAN message including the HRPD message with HO access info is used to trigger the terminal to perform handover to the HRPD network; or
the sending module 703 is further configured to send an RRC Connection Release message and a Mobility From EUTRAN message to the terminal when the fourth determining unit determines to perform non-optimized handover to the HRPD network, where the RRC Connection Release message is used to trigger the terminal to perform handover to the 1x network, and the Mobility From EUTRAN message is used to trigger the terminal to perform non-optimized handover to the HRPD network.

Persons of ordinary skill in the art may understand that, the foregoing embodiments are only exemplary embodiments of the present, which are not constructed as limitation to the patent, and that all other similar modification or variations fall within the scope of the patent.

The term “receiving” in the embodiments of the present invention may be either construed as actively obtaining information from other modules, or construed as receiving information sent by other modules. The foregoing modules may be combined into one module, or may be further split into multiple submodules.

Persons of ordinary skill in the art may understand that part of the steps of the method in the embodiments may be implemented by a program instructing relevant hardware. The program may be stored in a computer readable storage medium.

The sequence numbers of the embodiments of the present invention are used for description only and do not represent merits or demerits of the embodiments.

The solutions described in the claims also fall within the protection scope of the present invention.

Detailed above are merely exemplary embodiments of the present invention, and the protection scope of the present invention is not limited thereto. Any modification, equivalent replacement, or improvement made without departing from the spirit and principle of the present invention should fall within the protection scope of the present invention.

1. A method for handover, wherein the method comprises:
receiving, by an eNB, indication information from a mobility management entity, MME, wherein the indication information is used to indicate that a network side and a terminal support enhanced circuit switched fallback, CSFB, to a Code Division Multiple Access 2000, CDMA2000, 1x network, and determining to perform enhanced CSFB to the CDMA2000 1x network and determining to perform handover to a high rate packet data, HRPD, network; and
sending, by the eNB, a first message to the terminal, wherein the first message is used to trigger the terminal to perform enhanced CSFB to the CDMA2000 1x network and to perform handover to the HRPD network.

2. The method according to claim 1, wherein before the receiving, by the eNB, indication information from the MME, the method further comprises:
receiving, by the eNB, a capability of supporting simultaneous voice and data only, SVDO, of the terminal, wherein the SVDO capability is a network capability or a radio capability of the terminal.

3. The method according to claim 2, wherein the receiving, by an eNB, indication information from the MME, wherein the indication information is used to indicate that the network side and the terminal support enhanced CSFB to a CDMA2000 1x network, comprises one of:
receiving, by an eNB, enhanced CSFB Operation Possible indication information sent by the MME, wherein the indication information is used to indicate that the network side the and terminal support enhanced CSFB to the CDMA2000 1x network, after the MME receives an enhanced CSFB capability support indication reported by the terminal and the MME supports enhanced CSFB; or
receiving, by an eNB, enhanced CSFB indicator information sent by the MME, wherein the indicator information is used to indicate that the network side and the terminal support enhanced CSFB to the CDMA2000 1x network, after the terminal sends a Service Request including enhanced CSFB indicator information to the MME and the MME supports enhanced CSFB.

4. The method according to claim 3, wherein before the determining to perform handover to the HRPD network, the method further comprises:
obtaining, by the eNB, a measurement report comprising measurement information of the HRPD network and the CDMA2000 1x network from the terminal.

5. The method according to claim 3, wherein the determining to perform enhanced CSFB to the CDMA2000 1x network comprises:
preparing for handover to the CDMA2000 1x network, and determining to perform enhanced CSFB according to the capability of supporting SVDO of the terminal and the received enhanced CSFB Operation Possible indication information.

6. The method according to claim 5, wherein the enhanced CSFB capability support indication is reported by the terminal as a radio capability of the terminal, the method further comprises one of:
sending a first S1-AP message to the MME to indicate the MME to perform enhanced CSFB; or
receiving, by the MME, a second S1-AP message, and determining, by the MME, to perform enhanced CSFB according to the received second S1-AP message.

7. The method according to claim 1, wherein the determining to perform handover to the HRPD network comprises one of:
performing a process of preparing for handover to the HRPD network, and determining to perform optimized handover to the HRPD network according to network conditions; or
determining to perform non-optimized handover to the HRPD network according to network conditions.

8. The method according to claim 7, wherein the determining to perform optimized handover to the HRPD network according to network conditions, comprises one of:
determining to perform optimized handover to the HRPD network according to at least one of a preconfigured policy, PS optimized handover information, and measurement report information; or
the determining to perform non-optimized handover to the HRPD network according to network conditions, comprises:
determining to perform non-optimized handover to the HRPD network according to at least one of the preconfigured policy, optimized handover failure, and the network's nonsupport of optimized handover.

9. The method according to claim 1, wherein the method further comprises:
obtaining, by the eNB, a Handoff Direction message in a process of preparing for handover to the CDMA2000 1x network and an HRPD message with HO access information obtained in a process of preparing for handover to the HRPD network wherein the Handoff Direction message comprises access configuration information for handover to the CDMA2000 1x network, and the HRPD message with HO access information comprises handover access information;
wherein the sending, by the eNB, the first message to the terminal, wherein the first message is used to trigger the terminal to perform enhanced CSFB to the CDMA2000 1x network and to perform handover to the HRPD network, comprises:
coordinating, by the eNB, the Handoff Direction message obtained in the process of preparing for handover to the CDMA2000 1x network and the HRPD message with HO access information obtained in the process of preparing for handover to the HRPD network;
constructing, by the eNB, a Mobility From EUTRAN message, wherein the Mobility From EUTRAN message comprises the Handoff Direction message and the HRPD message with HO access information, wherein the Handoff Direction message is used to trigger the terminal to initiate optimized handover to the CDMA2000 1x network, and the HRPD message with HO access information is used to trigger the terminal to initiate optimized handover to the HRPD network; and
sending, by the eNB, the Mobility From EUTRAN message to the terminal.

10. The method according to claim 1, wherein the method further comprises:
obtaining, by the eNB, a Handoff Direction message in a process of preparing for handover to the CDMA2000 1x network and an HRPD message with HO access information obtained in a process of preparing for handover to the HRPD network wherein the Handoff Direction message comprises access configuration information for handover to the CDMA2000 1x network, and the HRPD message with HO access information comprises handover access information; and
wherein the sending, by the eNB, the first message to the terminal, wherein the first message is used to trigger the terminal to perform enhanced CSFB to the CDMA2000 1x network and to perform handover to the HRPD network, comprises:
sending, by the eNB, a Mobility From EUTRAN message comprising the handoff Direction message and a Mobility From EUTRAN message comprising the HRPD message with HO access information to the terminal, wherein the Mobility From EUTRAN message comprising the handoff Direction message is used to trigger the terminal to perform handover to the CDMA2000 1x network, and the Mobility From EUTRAN message comprising the HRPD message with HO access information is used to trigger the terminal to perform handover to the HRPD network.

11. The method according to claim 5, wherein the method further comprises:
obtaining, by the eNB, a Handoff Direction message in a process of preparing for handover to the CDMA2000 1x network wherein the Handoff Direction message comprises access configuration information for handover to the CDMA2000 1x network;
constructing, by the eNB, an HRPD non-optimized Redirection message, wherein the HRPD non-optimized Redirection message comprises at least one of HRPD Carrier information, HRPD cell information, and HRPD paging channel information;
wherein the sending, by the eNB, the first message to the terminal, wherein the first message is used to trigger the terminal to perform enhanced CSFB to the CDMA2000 1x network and to perform handover to the HRPD network, comprises:
coordinating, by the eNB, the Handoff Direction message obtained in the process of preparing for handover to the CDMA2000 1x network and the constructed the HRPD non-optimized Redirection message;
constructing a Mobility From EUTRAN message, wherein the Mobility From EUTRAN message comprises the Handoff Direction message and the HRPD non-optimized Redirection message, the Handoff Direction message is used to trigger the terminal to perform handover to the CDMA2000 1x network, and the HRPD non-optimized Redirection message is used to trigger the terminal to perform non-optimized handover to the HRPD network; and
sending, by the eNB, the Mobility From EUTRAN message to the terminal.

12. The method according to claim 5, wherein the sending, by the eNB, the first message to the terminal, wherein the first message is used to trigger the terminal to perform enhanced CSFB to the CDMA2000 1x network and to perform handover to the HRPD network, comprises:
sending, by the eNB, an RRC Connection Release message and a Mobility From EUTRAN message to the terminal, wherein the RRC Connection Release message is used to trigger the terminal to perform handover to the CDMA2000 1x network, and the Mobility From EUTRAN message is used to trigger the terminal to perform non-optimized handover to the HRPD network.

13. An apparatus for handover, wherein the apparatus comprises a receiving module, a determining module, and a sending module, wherein:
the receiving module is configured to receive indication information from a mobility management entity, MME, wherein the indication information is used to indicate that a network side and a terminal support enhanced circuit switched fallback, CSFB, to a Code Division Multiple Access 2000, CDMA2000, 1x network;
the determining module is configured to determine to perform enhanced CSFB to the CDMA2000 1x network and determine to perform handover to a high rate packet data, HRPD, network; and
the sending module is configured to send a first message to the terminal when the determining module determines to perform enhanced CSFB to the CDMA2000 1x network and determines to perform handover to the HRPD network, wherein the first message is used to trigger the terminal to perform enhanced CSFB to the CDMA2000 1x network and perform handover to the HRPD network.

14. The apparatus according to claim 13, wherein:
the receiving module is further configured to receive a measurement report comprising measurement information of the HRPD network and CDMA2000 1x network from the terminal, and send the measurement report information to the determining module.

15. The apparatus according to claim 14, wherein the determining module comprises a first determining unit and a second determining unit, wherein:
the first determining unit is configured to determine to perform optimized handover to the HRPD networks according to network conditions; and
the second determining unit is configured to determine to perform non-optimized handover to the HRPD network according to network conditions.

16. The apparatus according to claim 15, wherein the apparatus further comprises a coordinating module and a constructing module, wherein:
the receiving module is further configured to receive a Handoff Direction message in the process of preparing for handover to the CDMA2000 1x network and an HRPD message with HO access information received in the process of preparing for handover to the HRPD network;
the coordinating module is configured to coordinate the Handoff Direction message received by the receiving module in the process of preparing for handover to the CDMA2000 1x network and the HRPD message with HO access information received in the process of preparing for handover to the HRPD network received by the receiving module when the first determining unit determines to perform optimized handover to the HRPD network;
the constructing module is configured to construct a Mobility From EUTRAN message, wherein the Mobility From EUTRAN message comprises the Handoff Direction message and the HRPD message with HO access information; and
the sending module is configured to send the Mobility From EUTRAN message to the terminal.

17. The apparatus according to claim 15, wherein the apparatus further comprises a coordinating module and a constructing module, wherein:
the receiving module is further configured to receive a Handoff Direction message in the process of preparing for handover to the CDMA2000 1x network;
the constructing module is configured to construct an HRPD non-optimized Redirection message, wherein the HRPD non-optimized Redirection message comprises at least one of HRPD Carrier information, HRPD cell information, and HRPD paging channel information;
the coordinating module is configured to coordinate the Handoff Direction message received by the receiving module and the HRPD non-optimized Redirection message constructed by the constructing module when the second determining unit determines to perform non-optimized handover to the HRPD network;
the constructing module is further configured to construct a Mobility From EUTRAN message, wherein the Mobility From EUTRAN message comprises the Handoff Direction message and the HRPD non-optimized Redirection message; and
the sending module is configured to send the Mobility From EUTRAN message to the terminal.

18. The apparatus according to claim 15, wherein:
the receiving module is further configured to receive a Handoff Direction message in the process of preparing for handover to the CDMA2000 1x network and an HRPD message with HO access information received in the process of preparing for handover to the HRPD network; and
the sending module is further configured to send a Mobility From EUTRAN message comprising a handoff Direction message received by the receiving module and a Mobility From EUTRAN message comprising an HRPD message with HO access information received by the receiving module to the terminal when the first determining unit determines to perform optimized handover to the HRPD network, wherein the Mobility From EUTRAN message comprising the handoff Direction message is used to trigger the terminal to perform handover to the CDMA2000 1x network, and the Mobility From EUTRAN message comprising the HRPD message with HO access info is used to trigger the terminal to perform handover to the HRPD network.

19. The apparatus according to claim 15, wherein:
the sending module is further configured to send an RRC Connection Release message and a Mobility From EUTRAN message to the terminal when the second determining unit determines to perform non-optimized handover to the HRPD network, wherein the RRC Connection Release message is used to trigger the terminal to perform handover to the CDMA2000 1x network, and the Mobility From EUTRAN message is used to trigger the terminal to perform non-optimized handover to the HRPD network.
